(19) United States
(12) Patent Application Publication
(10) Pub. No.: US 2024/0138306 A1
(43) Pub. Date: May 2, 2024

(54) SYSTEM AND METHOD FOR AN AGRICULTURAL HARVESTER

(71) Applicant: CNH Industrial Brasil Ltda., Nova Lima (BR)

(72) Inventors: MAURICIO BLANCO INFANTINI, Sorocaba (BR); JOÃO AUGUSTO MARCOLIN LUCCA, Piracicaba (BR); ANDRÉ SATOSHI SEKI, Sorocaba (BR)

(21) Appl. No.: 18/498,949

(22) Filed: Oct. 31, 2023

(30) Foreign Application Priority Data
Oct. 31, 2022 (BR) 1020220220719

(51) Int. Cl. A01D 47/00; A01D 45/10

(52) U.S. Cl. CPC A01D 47/00; A01D 45/10

(57) ABSTRACT

A system for an agricultural harvester can include a topper assembly including a cutting disk configured to severe an upper portion of a crop. A sensor system including a first sensor may be configured to capture crop data associated with the crop. A computing system is operably coupled with the topper assembly and the sensor system. The computing system includes one or more processors and one or more non-transitory computer-readable media that collectively store instructions that, when executed by the one or more processors, configure the computing system to receive an input related to a defined offset, obtain the crop data from the sensor system, determine a target of the crop based at least partially on the crop data, and position the cutting disk at a cutting position along the crop.

### FIELD OF THE INVENTION

The present disclosure relates generally to agricultural harvesters, such as sugarcane harvesters, and, more particularly, to systems and methods for a topper assembly of the agricultural harvester.

### BACKGROUND OF THE INVENTION

Typically, agricultural harvesters include an assembly of processing components for processing harvested material. For instance, within a sugarcane harvester, a topper assembly can remove an upper portion of the sugar cane crop. The remaining sugarcane stalks may then be conveyed via a feed roller assembly to a chopper assembly that cuts or chops the sugarcane stalks into pieces or billets (e.g., six-inch cane sections). The processed harvested material discharged from the chopper assembly is then directed as a stream of billets and debris into a primary extractor, within which the airborne debris (e.g., dust, dirt, leaves, etc.) is separated from the sugarcane billets. The separated/cleaned billets then fall into an elevator assembly for delivery to an external storage device.

During the operation of the harvester, the amount of harvested material that may be delivered to the external storage device is at least partially based on the amount of stalk that is severed by the topper assembly. Accordingly, systems and methods for monitoring the topper assembly would be welcomed in the technology.

### BRIEF DESCRIPTION OF THE INVENTION

Aspects and advantages of the invention will be set forth in part in the following description, or may be obvious from the description, or may be learned through practice of the invention.

In some aspects, the present subject matter is directed to a system for an agricultural harvester. The system includes a topper assembly including a cutting disk configured to severe an upper portion of a crop. A sensor system includes a first sensor configured to capture crop data associated with the crop. A computing system includes one or more processors and one or more non-transitory computer-readable media that collectively store instructions that, when executed by the one or more processors, configure the computing system to perform operations. The operations include receiving an input related to a defined offset, receiving the crop data from the sensor system, determining a target of the crop based at least partially on the crop data, and positioning the cutting disk at a cutting position along the crop, wherein the cutting position is the defined offset below the target.

In some aspects, the present subject matter is directed to a computer-implemented method for agricultural harvesting. The method can include receiving, from an input device, an input related to a defined offset. The method can also include receiving, from a sensor system, crop data. The method further includes determining a target of the crop based at least partially on the crop data. Lastly, the method includes positioning a cutting disk at a cutting position along the crop, wherein the cutting position is the defined offset below the target.

In some aspects, the present subject matter is directed to a system for an agricultural harvester. The system includes a topper assembly including a cutting disk configured to severe an upper portion of a crop. A sensor system includes a first sensor configured to capture crop data associated with the crop. A computing system includes one or more processors and one or more non-transitory computer-readable media that collectively store instructions that, when executed by the one or more processors, configure the computing system to perform operations. The operations include receiving an input related to a defined offset, receiving the crop data from the sensor system, determining a maximum height of the crop based at least partially on the crop data, and positioning the cutting disk at a cutting position along the crop, wherein the cutting position is the defined offset below the maximum height.

These and other features, aspects, and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a simplified, side view of an agricultural harvester in accordance with aspects of the present subject matter;

FIG. 2 illustrates a side view of a portion of the harvester having a topper assembly within a field in accordance with aspects of the present subject matter;

FIG. 3 illustrates a schematic view of a system for a harvesting operation in accordance with aspects of the present subject matter;

FIG. 4 illustrates a side view of the topper assembly in accordance with aspects of the present subject matter;

FIG. 5 illustrates a side view of the topper assembly in accordance with aspects of the present subject matter;

FIG. 6 illustrates a side view of a portion of the harvester having a topper assembly within a field in accordance with aspects of the present subject matter; and

FIG. 7 illustrates a flow diagram of a method for a harvesting operation in accordance with aspects of the present subject matter.

Repeat use of reference characters in the present specification and drawings is intended to represent the same or analogous features or elements of the present technology.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part can be used with another embodiment to yield a still further embodiment. Thus, it is intended that the present invention covers such modifications and variations as come within the scope of the appended claims and their equivalents.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the terms “first,” “second,” and “third” may be used interchangeably to distinguish one component from another and are not intended to signify a location or importance of the individual components. The terms “coupled,” “fixed,” “attached to,” and the like refer to both direct coupling, fixing, or attaching, as well as indirect coupling, fixing, or attaching through one or more intermediate components or features, unless otherwise specified herein. The terms “upstream” and “downstream” refer to the relative direction with respect to a harvested material within a fluid circuit. For example, “upstream” refers to the direction from which a harvested material flows, and “downstream” refers to the direction to which the harvested material moves. The term “selectively” refers to a component's ability to operate in various states (e.g., an ON state and an OFF state) based on manual and/or automatic control of the component.

Furthermore, any arrangement of components to achieve the same functionality is effectively “associated” such that the functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected” or “operably coupled” to each other to achieve the desired functionality, and any two components capable of being so associated can also be viewed as being “operably couplable” to each other to achieve the desired functionality. Some examples of operably couplable include, but are not limited to, physically mateable, physically interacting components, wirelessly interactable, wirelessly interacting components, logically interacting, and/or logically interactable components.

The singular forms “a,” “an,” and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about,” “approximately,” “generally,” and “substantially,” is not to be limited to the precise value specified. In at least some instances, the approximating language may correspond to the precision of an instrument for measuring the value, or the precision of the methods or apparatus for constructing or manufacturing the components and/or systems. For example, the approximating language may refer to being within a ten percent margin.

As used herein, a “desired foliage ratio” may be an input that is defined by an operator and/or any device. In addition, a “current foliage ratio” may be a detected foliage ratio of the system while the system is operating.

Moreover, the technology of the present application will be described in relation to exemplary embodiments. The word “exemplary” is used herein to mean “serving as an example, instance, or illustration.” Any embodiment described herein as “exemplary” is not necessarily to be construed as preferred or advantageous over other embodiments. Additionally, unless specifically identified otherwise, all embodiments described herein will be considered exemplary.

As used herein, the term “and/or,” when used in a list of two or more items, means that any one of the listed items can be employed by itself, or any combination of two or more of the listed items can be employed. For example, if a composition or assembly is described as containing components A, B, and/or C, the composition or assembly can contain A alone; B alone; C alone; A and B in combination; A and C in combination; B and C in combination; or A, B, and C in combination.

In general, the present subject matter is directed to systems and methods for agricultural harvesters. The system can include a topper assembly including a cutting disk configured to severe an upper portion of the sugar cane crop. The remaining sugarcane stalks may then be conveyed via a feed roller assembly to a chopper assembly that cuts or chops the sugarcane stalks into pieces or billets (e.g., six-inch cane sections). The processed harvested material discharged from the chopper assembly is then directed as a stream of billets and debris into a primary extractor, within which the airborne debris (e.g., dust, dirt, leaves, etc.) is separated from the sugarcane billets.

A sensor system includes a first sensor configured to capture crop data associated with the crop. In some instances, the first sensor is a vision-based sensor. In such instances, the crop data is image data.

A computing system includes one or more processors and one or more non-transitory computer-readable media that collectively store instructions that, when executed by the one or more processors, configure the computing system to perform operations. The operations can include receiving an input related to a defined offset and receiving the crop data from the sensor system. The operations can also include determining a target of the crop based at least partially on the crop data. In some instances, the target is a maximum height of the crop. The operations can further include positioning the cutting disk at a cutting position along the crop, wherein the cutting position is equal to the defined offset below the target. As such, the upper portions of the crop may be generally uniformly removed based on an offset from the target (e.g., the maximum height of the crop). In such instances, the topper assembly may remove the generally non-harvestable portion of the crop without having to capture data of a transition region between the upper portion and the stalk, which may have minimal or no visibility during a harvesting operation.

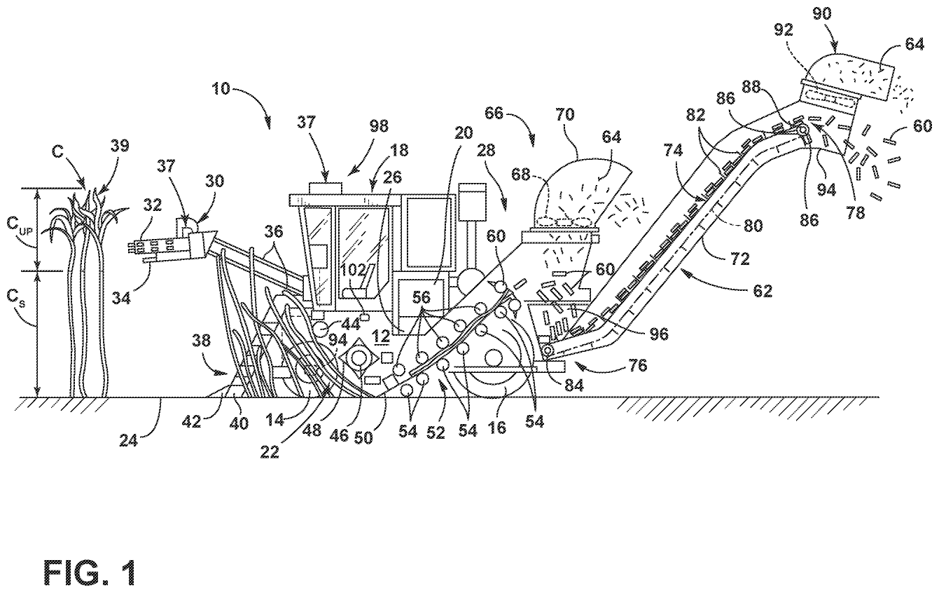

Referring now to the drawings, FIG. 1 illustrates a side view of an agricultural harvester 10 in accordance with aspects of the present subject matter. As shown, the harvester 10 is configured as a sugarcane harvester. The sugarcane may include an upper portion that includes one or more leaves and a stalk Cₛ below the upper portion Cᵤₚ. It will be appreciated that, in other embodiments, the harvester 10 may correspond to any other suitable agricultural harvester capable of harvesting any other crop without departing from the teachings provided herein.

As shown in FIG. 1, the harvester 10 can include a frame 12, a pair of front wheels 14, a pair of rear wheels 16, and an operator's cab 18. The harvester 10 may also include a power source 20 (e.g., an engine mounted on the frame 12) that powers one or both pairs of wheels 14, 16 via a driveline assembly 22 (e.g., a transmission) to traverse a field 24. Alternatively, the harvester 10 may be a track-driven harvester and, thus, may include tracks driven by the power source 20 as opposed to the illustrated wheels 14, 16. The power source 20 may also drive a hydraulic fluid pump 26 to power various components of the harvester 10, including the driveline assembly 22.

The harvester 10 may also include a harvested material processing system 28 incorporating various components, assemblies, and/or sub-assemblies of the harvester 10 for cutting, processing, cleaning, and discharging sugarcane as the stalk Cₛ is harvested from an agricultural field 24. For instance, the harvested material processing system 28 may include a topper assembly 30 positioned at the front end portion of the harvester 10 to intercept sugarcane as the harvester 10 is moved in a forward direction. As shown, the topper assembly 30 may include a gathering disk 32 and/or a cutting disk 34. The gathering disk 32 may be configured to gather the sugarcane stalks Cₛ so that the cutting disk 34 may be used to cut off an upper portion Cᵤₚ of each stalk Cₛ. The height of the topper assembly 30 may be adjustable, which may be raised and lowered by an adjustment assembly 35 that may be hydraulically powered by the hydraulic fluid pump 26 and/or through any other manner (e.g., electrically power, mechanically power; manually adjusted, etc.). In some examples, the adjustment assembly 35 may include a pair of arms 36 for adjusting a height of the topper assembly. Additionally or alternatively, the adjustment assembly 35 may allow for the arms 36 and the topper assembly 30 to rotate relative to the frame 12 of the harvester 10 and/or the topper assembly 30 to rotate relative to the arms 36.

The harvested material processing system 28 may also include a sensor system 37 that is configured to capture data associated with the crop C. Based on the data, the adjustment assembly 35 may alter the height of the topper assembly 30. For example, in some cases, the sensor system 37 may capture data indicative of a target 39 (e.g., maximum height) of the crop C. Based on the position of the target 39 of the crop C, the adjustment assembly 35 may alter the height of the topper assembly 30 so that a generally common upper portion Cᵤₚ height may be removed from each of the crops C harvested by the harvester 10.

The harvested material processing system 28 may further include a harvested material divider 38. In general, the harvested material divider 38 may include one or more spiral feed rollers 40. Each feed roller 40 may include a ground shoe 42 at its lower end portion to assist the harvested material divider 38 in gathering the sugarcane stalks Cₛ for harvesting.

Moreover, as shown in FIG. 1, the harvested material processing system 28 may include a knock-down roller 44 positioned near the front wheels 14 and a fin roller 46 positioned behind the knock-down roller 44. As the knock-down roller 44 is rotated, the sugarcane stalks Cₛ being harvested are knocked down while the harvested material divider 38 gathers the stalks Cₛ from agricultural field 24. Further, as shown in FIG. 1, the fin roller 46 may include a plurality of intermittently mounted fins 48 that assist in forcing the sugarcane stalks Cₛ downwardly. As the fin roller 46 is rotated during the harvest, the sugarcane stalks Cₛ that have been knocked down by the knock-down roller 44 are separated and further knocked down by the fin roller 46 as the harvester 10 continues to be moved in the forward direction relative to the field 24.

Referring still to FIG. 1, the harvested material processing system 28 of the harvester 10 may also include a base cutter assembly 50 positioned behind the fin roller 46. The base cutter assembly 50 may include blades for severing the sugarcane stalks Cₛ as the sugarcane is being harvested. The blades, which may be located on a periphery section of the base cutter assembly 50, may be rotated by a hydraulic circuit. Additionally, in several embodiments, the blades may be angled downwardly to sever the base of the sugarcane as the cane is knocked down by the fin roller 46.

Moreover, the harvested material processing system 28 may include a feed roller assembly 52 located downstream of the base cutter assembly 50 for moving the severed stalks Cₛ of sugarcane from base cutter assembly 50 along the processing path of the harvested material processing system 28. As shown in FIG. 1, the feed roller assembly 52 may include a plurality of bottom rollers 54 and a plurality of opposed, top rollers 56. The various bottom and top rollers 54, 56 may be used to pinch the harvested sugarcane during transport. As the sugarcane is transported through the feed roller assembly 52, debris (e.g., rocks, dirt, and/or the like) may be allowed to fall through bottom rollers 54 onto the field 24.

In addition, the harvested material processing system 28 may include a chopper assembly 58 located at the downstream end section of the feed roller assembly 52 (e.g., adjacent to the rearward-most bottom roller 54 and the rearward-most top roller 56). In general, the chopper assembly 58 may be used to cut or chop the severed sugarcane stalks Cₛ into pieces or “billets” 60, which may be, for example, six (6) inches long. The billets 60 may then be propelled towards an elevator assembly 62 of the harvested material processing system 28 for delivery to an external receiver or storage device.

The pieces of debris 64 (e.g., dust, dirt, leaves, etc.) separated from the sugarcane billets 60 may be expelled from the harvester 10 through a primary extractor 66 of the harvested material processing system 28, which may be located downstream of the chopper assembly 58 and may be oriented to direct the debris 64 outwardly from the harvester 10. Additionally, an extractor fan 68 may be mounted within an extractor housing 70 of the primary extractor 66 for generating a suction force or vacuum sufficient to force the debris 64 through the primary extractor 66. The separated or cleaned billets 60, which may be heavier than the debris 64 expelled through the extractor 54, may then fall downward to the elevator assembly 62.

As shown in FIG. 1, the elevator assembly 62 may include an elevator housing 72 and an elevator 74 extending within the elevator housing 72 between a lower, proximal end portion 76 and an upper, distal end portion 78. In some examples, the elevator 74 may include a looped chain 80 and a plurality of flights or paddles 82 attached to and spaced on the chain 80. The paddles 82 may be configured to hold the sugarcane billets 60 on the elevator 74 as the sugarcane billets 60 are elevated along a top span of the elevator 74 defined between its proximal and distal end portions 76, 78. Additionally, the elevator 74 may include lower and upper sprockets 84, 86 positioned at its proximal and distal end portions 76, 78, respectively. As shown in FIG. 1, an elevator motor 88 may be coupled to one of the sprockets (e.g., the upper sprocket 86) for driving the chain 80, thereby allowing the chain 80 and the paddles 82 to travel in a loop between the proximal and distal ends 76, 78 of the elevator 74.

Moreover, in some embodiments, pieces of debris 64 (e.g., dust, dirt, leaves, etc.) separated from the elevated sugarcane billets 60 may be expelled from the harvester 10 through a secondary extractor 90 of the harvested material processing system 28 coupled to the rear end portion of the elevator housing 72. For example, the debris 64 expelled by the secondary extractor 90 may be debris 64 remaining after the billets 60 are cleaned and debris 64 expelled by the primary extractor 66. As shown in FIG. 1, the secondary extractor 90 may be located adjacent to the distal end portion 78 of the elevator 74 and may be oriented to direct the debris 64 outwardly from the harvester 10. Additionally, an extractor fan 92 may be mounted at the base of the secondary extractor 90 for generating a suction force or vacuum sufficient to force the debris 64 through the secondary extractor 90. The separated, cleaned billets 60, heavier than the debris 64 expelled through the primary extractor 66, may then fall from the distal end portion 78 of the elevator 74. In some instances, the billets 60 may fall downwardly into an elevator discharge opening 94 defined by the elevator assembly 62 into an external storage device, such as a sugarcane billet cart.

During operation, the harvester 10 traverses the agricultural field 24 for harvesting sugarcane and receives data related to a target 39 (e.g., a maximum height) of the approaching crop C. Based at least partially on the target 39 (e.g., a maximum height) (and/or any other input), the height of the topper assembly 30 is adjusted via the adjustment assembly 35 based on a defined offset from the target 39 (e.g., a maximum height). With the topper assembly 30 positioned in a defined position based on the defined offset from the target 39 (e.g., a maximum height), the gathering disk 32 on the topper assembly 30 may function to gather the sugarcane stalks Cₛ as the harvester 10 proceeds across the field 24, while the cutting disk 34 severs the upper portions Cᵤₚ f the sugarcane crop C for disposal. As the stalks Cₛ enter the harvested material divider 38, the ground shoes 42 may set the operating width to determine the quantity of sugarcane entering the throat of the harvester 10. The spiral feed rollers 40 then gather the stalks Cₛ into the throat to allow the knock-down roller 44 to bend the stalks Cₛ downwardly in conjunction with the action of the fin roller 46. Once the stalks Cₛ are angled downward as shown in FIG. 1, the base cutter assembly 50 may then sever the base of the stalks Cₛ from field 24. The severed stalks Cₛ are then, by the movement of the harvester 10, directed to the feed roller assembly 52.

The severed sugarcane stalks Cₛ are conveyed rearwardly by the bottom and top rollers 54, 56, which compresses the stalks Cₛ, making them more uniform, and shakes loose debris 64 to pass through the bottom rollers 54 to the field 24. At the downstream end portion of the feed roller assembly 52, the chopper assembly 58 cuts or chops the compressed sugarcane stalks Cₛ into pieces or billets 60 (e.g., 6-inch cane sections). The processed harvested material discharged from the chopper assembly 58 is then directed as a stream of billets 60 and debris 64 into the primary extractor 66. The airborne debris 64 (e.g., dust, dirt, leaves, etc.) separated from the billets 60 is then extracted through the primary extractor 66 using suction created by the extractor fan 68. The separated/cleaned billets 60 may then be directed to an elevator hopper 96 into the elevator assembly 62 and travel upwardly via the elevator 74 from its proximal end portion 76 to its distal end portion 78. Once the billets 60 reach the distal end portion 78 of the elevator 74, the billets 60 fall through the elevator discharge opening 94 to an external storage device. If provided, the secondary extractor 90 (with the aid of the extractor fan 92) blows out trash/debris 64 from the harvester 10, similar to the primary extractor 66.

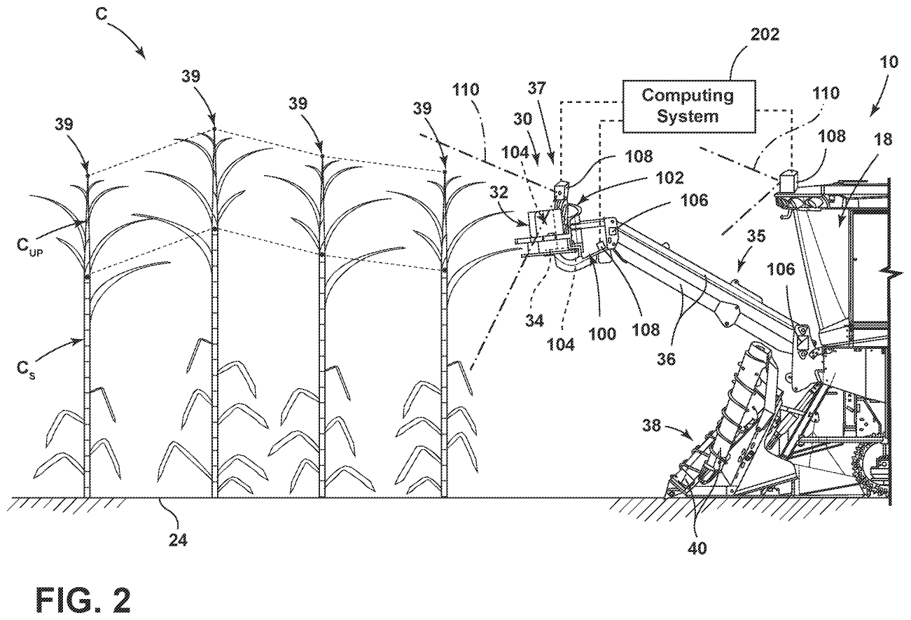

Referring now to FIG. 2, a side view of a portion of the harvester 10 within a field 24 is illustrated in accordance with aspects of the present subject matter. As shown in FIG. 2, the topper assembly 30 may include a frame 100 and a deflector 102. The topper assembly may further include a pair of gathering disks 32 and/or a cutting disk 34 positioned on an opposing side of the deflector 102 from the cab 18 of the harvester 10. The gathering disk 32 may be configured to gather the sugarcane stalks Cₛ so that the cutting disk 34 may be used to cut off an upper portion Cᵤₚ of each stalks Cₛ. As illustrated, each of the pair of gathering disks 32 and/or a cutting disk 34 may be operably coupled with an actuation device 104, such as a motor, which may be hydraulically powered, pneumatically powered, electrically powered, and/or powered through any other source. Each of the pair of gathering disks 32 and/or a cutting disk 34 may be respectively coupled with independent actuation devices 104. Alternatively, any of the pair of gathering disks 32 and/or a cutting disk 34 may share a common actuation device 104.

The topper assembly 30 may be operably coupled with the remaining portions of the harvester 10, such as the frame 12, through an adjustment assembly 35. The adjustment assembly 35 may include one or more arms 36 and an actuation system 106. The actuation system 106 may be hydraulically powered, pneumatically powered, electrically powered, and/or powered through any other source for moving the topper assembly 30 between a plurality of positions relative to the field 24.

The topper assembly 30 may further include the sensor system 37. The sensor system 37 may include one or more sensors 108 that may be operably coupled with the topper assembly 30, the adjustment assembly 35, and/or any other component of the harvester 10 (e.g., the cab 18 of the harvester 10). In general, the sensor system 37 may be configured to capture data associated with the operation of one or more components of the harvester 10 and/or crop data associated with the field 24 surrounding the vehicle. For instance, the sensor system 37 may include one or more sensors 108 that capture crop data related to the to-be-harvested crops C. In some cases, the crop data related to the harvested crops C can include a type of crop C to be harvested, a target 39 (e.g., a maximum height) of the crops C, the location/position of the crops C, and/or any other information.

In some examples, the one or more sensors 108 may be vision-based or wave-based (e.g., cameras/imagers, radar sensors, ultrasound sensors, LIDAR devices, etc.). For instance, as shown in FIG. 2, a forward-looking vision-based sensor may be installed on the topper assembly 30 with a field of view 110 directed in front of the top assembly to allow images or other vision-based data to be captured that provides an indication of the upcoming harvested material height within the field 24. Additionally or alternatively, as shown in FIG. 2, a vision-based sensor may be installed on the cab 18 with a field of view 110 directed forwardly and/or laterally outward from the cab 18 to allow images or other vision-based data to be captured that indicate the upcoming harvested material height within the field 24 and/or a ground height of a portion of a field 24 that has been harvested.

Additionally or alternatively, the sensor system 37 can include one or more sensors 108 that are configured to capture operation-related data associated with the operating conditions of the topper assembly 30. The operating conditions may include an operational status of the pair of gathering disks 32 and/or a cutting disk 34, a height of the cutting disk 34, a tilt angle of the topper assembly 30 relative to the field 24 and/or the frame 12 of the harvester 10, and/or any other operating condition.

In some instances, the sensor 108 can be configured as a pressure sensor that may provide data indicative of a pressure with one or more of the motors, thereby indicating an operating condition of the gathering disk 32 and/or cutting disk 34 operably coupled with the motor. Additionally or alternatively, the sensors 108 can be configured as a position sensor used to monitor a position of the arms 36 and/or a component of the topper assembly 30.

The topper assembly 30, the adjustment assembly 35, and/or the sensor system 37 may be operably coupled with a computing system 202. The computing system 202 may further be configured to receive an input related to a defined offset. The defined offset may be a defined height of the upper portion Cᵤₚ of the to-be-harvested crop C that is to be severed from the remaining stalks Cₛ.

In operation, the sensor system 37 may capture crop data related to a target 39 (e.g., a maximum height) of a to-be-harvested crop C. In turn, the computing system 202 may determine a cutting position of the cutting disk 34 to severe an upper portion Cᵤₚ of the crop C having a height that is equal to the defined offset. The computing system 202, based on the determined cutting position, may activate the adjustment assembly 35 to set a height of the cutting disk 34 at the cutting position. As the harvester 10 moves through the field 24, the target 39 of subsequent to-be-harvested crops C is determined based on the crop data, which is then used to alter the position of the cutting disk 34, such as when the target 39 of a subsequent to be harvested crop C is varied from the previously harvested crop C. The movement of the cutting disk 34 may be generally equal to the difference in target height of the previous crop C to the subsequent crop C. As such, in some instances, the severed upper portion Cᵤₚ of each harvested crop C may be within a defined range while the height of each stalks Cₛ may be varied from one or more other stalks Cₛ.

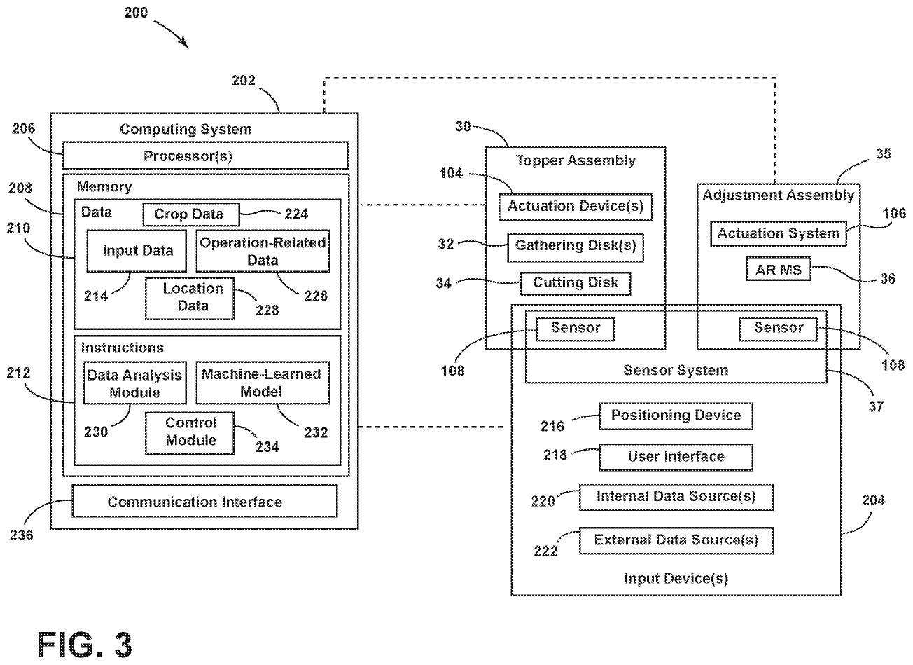

Referring now to FIG. 3, a schematic view of embodiments of a system 200 is illustrated in accordance with aspects of the present subject matter. In general, the system 200 will be described herein with reference to the harvester 10 described above with reference to FIGS. 1 and 2. However, it will be appreciated that the disclosed system 200 may generally be utilized with harvesters having any suitable harvester configuration.

In several embodiments, the system 200 may include a computing system 202 and various other components configured to be communicatively coupled to and/or controlled by the computing system 202, such as various input devices 204 and/or various components of the harvester 10. In some embodiments, the computing system 202 can operate to determine a target 39 (e.g., a maximum height) of a to-be-harvested crop based at least in part on crop data captured by one or more sensors 108 and, further, to initiate one or more control actions associated with a harvester 10, such as by altering a height of a topper assembly 30 based on a defined offset from the target 39 (e.g., a maximum height). In various instances, the computing system 202 is physically coupled to the harvester 10. In other embodiments, the computing system 202 is not physically coupled to the harvester 10 (e.g., the computing system 202 may be remotely located from the harvester 10) and instead may communicate with the harvester 10 over a wireless network.

In general, the computing system 202 may correspond to any suitable processor-based device(s), such as a computing device or any combination of computing devices. Thus, as shown in FIG. 3, the computing system 202 may generally include one or more processor(s) 206 and associated memory devices 208 configured to perform a variety of computer-implemented functions (e.g., performing the methods, steps, algorithms, calculations, and the like disclosed herein). As used herein, the term “processor” refers not only to integrated circuits referred to in the art as being included in a computer, but also refers to a controller, a microcontroller, a microcomputer, a programmable logic controller (PLC), an application-specific integrated circuit, and other programmable circuits. Additionally, the memory 208 may generally include memory element(s) including, but not limited to, computer-readable medium (e.g., random access memory (RAM)), computer-readable non-volatile medium (e.g., a flash memory), a floppy disk, a compact disc-read only memory (CD-ROM), a magneto-optical disk (MOD), a digital versatile disc (DVD) and/or other suitable memory elements. Such memory 208 may generally be configured to store information accessible to the processor(s) 206, including data 210 that can be retrieved, manipulated, created, and/or stored by the processor(s) 206 and instructions 212 that can be executed by the processor(s) 206.

In several embodiments, the data 210 may be stored in one or more databases. For example, the memory 208 may include an input database 214 for storing input data received from the input device(s) 204. In some examples, the input device(s) 204 may include the sensor system 37, one or more positioning device(s) 216 for generating position data associated with the location of the harvester 10, one or more user interfaces 218 for allowing operator inputs to be provided to the computing system 202 (e.g., buttons, knobs, dials, levers, joysticks, touch screens, and/or the like), one or more other internal data sources 220 associated with the harvester 10 (e.g., other devices, databases, etc.), one or more external data sources 222 (e.g., a remote computing device or server, including, for instance, a machine-learning computing system 202), and/or any other suitable input device(s). The data received from the input device(s) 204 may, for example, be stored within the input database 214 for subsequent processing and/or analysis.

It will be appreciated that, in addition to being considered an input device(s) 204 that allows an operator to provide inputs to the computing system 202, the user interfaces 218 may also function as an output device. For example, the user interfaces 218 may be configured to allow the computing system 202 to provide feedback to the operator (e.g., visual feedback via a display or other presentation device, audio feedback via a speaker or other audio output device, and/or the like).

As shown in FIG. 3, the memory 208 may also include a crop-related database 224 for storing information or data associated with to-be-harvested crops and/or the field 24. For example, as indicated above, based on the crop data received from the input device(s) 204, the computing system 202 may be configured to estimate or calculate a type of crop to be harvested, a target 39 (e.g., a maximum height) of the crops, the location/position of the crops, and/or any other information. The crop data may then be stored within the crop-related database 224 for subsequent processing and/or analysis.

Additionally, as shown in FIG. 3, the memory 208 may include an operation-related database 226 for storing information or data associated with the harvest-related parameter(s) for the harvester 10. For example, as indicated above, based on the input data received from the input device(s) 204, the computing system 202 may be configured to estimate or calculate a position of the topper assembly 30 such that the cutting disk 34 is positioned at the cutting position, which is the distance from the target 39 that is equal to the defined offset from the target 39 (e.g., a maximum height) of the to be harvested crop. The topper assembly 30 position may then be stored within the operation-related database 226 for subsequent processing and/or analysis.

Moreover, in several embodiments, the memory 208 may also include a location database 228 storing location information about the harvester 10 and/or information about the field 24 being processed (e.g., a field map). Such location database 228 may, for example, correspond to a separate database or may form part of the input database 214. As shown in FIG. 3, the computing system 202 may be communicatively coupled to the positioning device(s) 216 installed on or within the harvester 10. For example, in some embodiments, the positioning device(s) 216 may be configured to determine the exact location of the harvester 10 using a satellite navigation position system (e.g., a GPS, a Galileo positioning system, the Global Navigation satellite system (GLONASS), the BeiDou Satellite Navigation and Positioning system, and/or the like). In such an embodiment, the location determined by the positioning device(s) 216 may be transmitted to the computing system 202 (e.g., in the form of coordinates) and subsequently stored within the location database 228 for subsequent processing and/or analysis.

Additionally, in several embodiments, the location data stored within the location database 228 may also be correlated to all or a portion of the input data stored within the input database 214. For instance, in some embodiments, the location coordinates derived from the positioning device(s) 216 and the data received from the input devices 204 may both be time-stamped. In such an embodiment, the time-stamped data may allow the data received from the input devices 204 to be matched or correlated to a corresponding set of location coordinates received from the positioning device(s) 216, thereby allowing the precise location of the portion of the field 24 associated with the input data to be known (or at least capable of calculation) by the computing system 202.

Moreover, by matching the input data to a corresponding set of location coordinates, the computing system 202 may also be configured to generate or update a corresponding field map associated with the field 24 being processed. For example, in instances in which the computing system 202 already includes a field map stored within its memory 208 that includes location coordinates associated with various points across the field 24, the input data received from the input devices 204 may be mapped or correlated to a given location within the field map. Alternatively, based on the location data and the associated image data, the computing system 202 may be configured to generate a field map for the field 24 that includes the geo-located input data associated therewith.

Referring still to FIG. 3, in several embodiments, the instructions 212 stored within the memory 208 of the computing system 202 may be executed by the processor(s) 206 to implement a data analysis module 230. In general, the data analysis module 230 may be configured to analyze the crop data (e.g., a set of crop data received at a given time or within a given time period or a subset of the crop data, which may be determined through a pre-processing method) to determine the target 39 (e.g., a maximum height) of the crops using any algorithm. In some instances, the data analysis module 230 can cooperatively operate with or otherwise leverage a machine-learned model 232 to analyze the crop data 224 to determine the target 39 (e.g., a maximum height) of the crops. In some embodiments, a color-based algorithm may be utilized that relies on color differences to determine a target 39 (e.g., a maximum height) of the crop. In further embodiments, the model may include an algorithm that identifies the differences in the reflectivity or spectral absorption between the upper portion Cᵤₚ of the crop and the stalks Cₛ contained within the data.

Additionally or alternatively, the data analysis module 230 may be configured to analyze the operation-related data (e.g., a set of operation-related data received at a given time or within a given time period or a subset of the operation-related data, which may be determined through a pre-processing method) to determine the position of the cutting disk 34 using any algorithm. In some instances, the data analysis module 230 can cooperatively operate with or otherwise leverage a machine-learned model 232 to analyze the operation-related data 226 to determine the position of the cutting disk 34.

Referring still to FIG. 3, the instructions 212 stored within the memory 208 of the computing system 202 may also be executed by the processor(s) 206 to implement a control module 234. The control module 234 may be configured to adjust the position of the cutting disk 34 when the position of the cutting disk 34 is varied from a cutting position by controlling one or more components of the adjustment assembly 35. In general, the cutting position is defined as a position along the crop that is a defined offset below the target 39 (e.g., a maximum height) of the crop. Thus, the system can detect a target 39 (e.g., a maximum height) of the processed crop and reactively adjust a position of the topper assembly 30 so that a generally common upper portion C^{up} height is severed from the crop.

Moreover, as shown in FIG. 3, the computing system 202 may also include a communications interface 236 to communicate with any of the various other system components described herein. For instance, one or more communicative links or interfaces (e.g., one or more data buses and/or wireless connections) may be provided between the communications interface 236 and the input device(s) 204 to allow data transmitted from the input device(s) 204 to be received by the computing system 202. Additionally, as shown in FIG. 3, one or more communicative links or interfaces (e.g., one or more data buses and/or wireless connections) may be provided between the communications interface 236 and one or more electronically controlled components of the harvester 10 to allow the computing system 202 to control the operation of such system components.

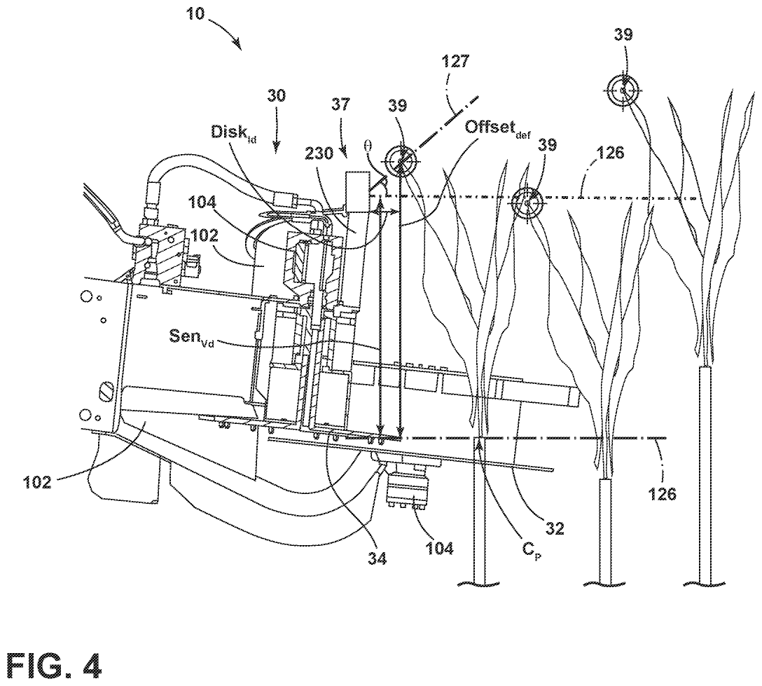

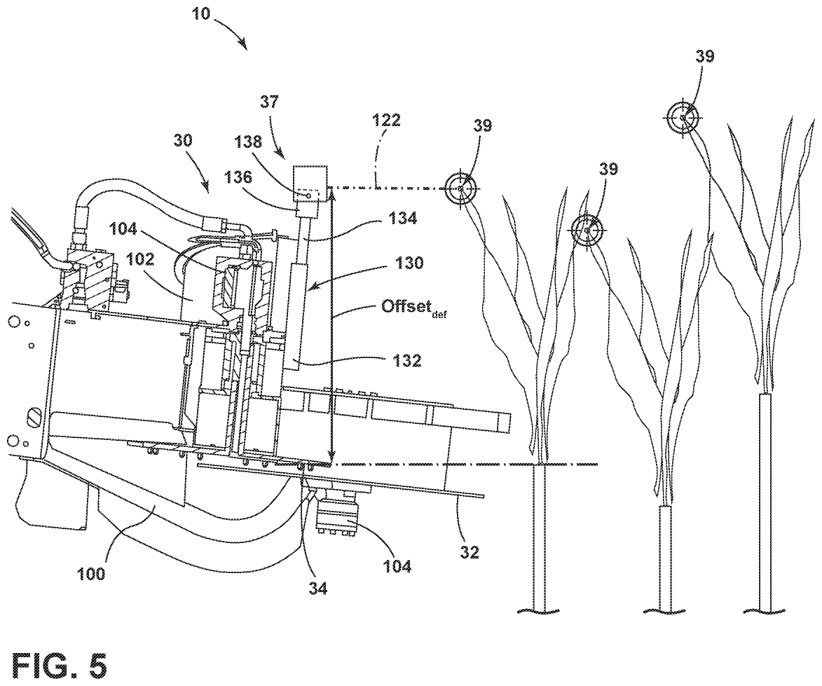

Referring now to FIGS. 4 and 5, in various examples, a sensor 108 may be installed on the topper assembly 30 (and/or any other location of the harvester 10) for capturing crop data. As provided herein, the sensor 108 may be configured to capture vision-based data of the to-be-harvested crop C (and/or previously harvested portions of the field 24). Based on the captured crop data, a position of the cutting disk 34 of the topper assembly 30 may be altered to remove an upper portion C^{up} of the crop C.

As illustrated, the sensor 108 may be mounted to the deflector 102, a housing 120 of the cutting disk 34, and/or to any other component of the topper assembly 30. The sensor 108 may be configured to capture vision-based crop data relative to a focal axis 122 of the sensor 108. The computing system 202 may determine a target 39 (e.g., a maximum height) of a crop C forwardly of the topper assembly 30 based at least partially on the crop data. Additionally or alternatively, the crop data can include a type of crop C to be harvested, a location/position of the crops C, and/or any other information.

As shown in FIG. 4, the sensor 108 may have a focal axis 122 that is offset from a horizontal axis 124 relative to the frame 12 of the harvester 10 and/or parallel a cutting axis 126 that extends vertically forward of the cutting position. As shown, an offset angle 0 may be defined between the horizontal axis 124 and the focal axis 122 and is based on a defined offset from the target 39 (e.g., a maximum height) of the crop C that is to be severed from the crop C. In some instances, to align the target 39 (e.g., a maximum height) with the focal axis 122 of the sensor 108 at the time the upper portion Cᵤₚ is to be severed, the offset angle may be determined by the following equation:

$$θ = {tan}^{- 1} ( \frac{( {Offset}_{def} - {Sen}_{v d} )}{{Disk}_{l d}} ) , \qquad ( 1 )$$

where θ is the offset angle, Offset_{def} is the defined offset, which is a defined input, Sen_{vd} is the vertical distance of a sensor focal axis 122 from the cutting disk 34, and Disk_{ld} is the lateral offset distance from the cutting disk 34 to the sensor 108.

In operation, the defined offset may an operator-generated input, a computer-generated input, and/or a combination thereof. In instances in which the defined offset is at least partially based on computer-generated input, the input may be based at least in part on detected crop types within the field 24, historical data, previously-captured crop data from a previous pass within the field 24, and/or any other factor. Once the defined offset is received, the computing system 202 may determine the offset angle for aligning the cutting disk 34 at a defined cutting position Cₚ below a detected target 39 (e.g., a maximum height) such that a height of the upper portion Cᵤₚ of the crop C that is severed by the cutting disk 34 is generally equal to the defined offset. As an upper portion Cᵤₚ of each crop C is severed, the sensor 108 may have visibility to a subsequent crop C and move the topper assembly 30 to align the focal axis 122 with the subsequent crop C to severe an upper portion Cᵤₚ of the subsequent crop C that is generally similar in height to the previously severed upper portion Cᵤₚ. The alterations of the cutting disk 34 may continue while the crop C is harvested.

With further reference to FIG. 5, in some cases, the sensor 108 may be operably coupled with a support bracket 130. The support bracket 130 may include first and second portions 132, 134 that are movable relative to one another such that the height of the sensor 108 from the cutting disk 34 may be varied. In some instances, the movement of the sensor 108 may be done manually. Additionally or alternatively, one or more actuators 136 may be hydraulically powered, pneumatically powered, electrically powered, and/or powered through any other source. In some cases, the one or more actuators 136 may additionally or alternatively rotate the sensor 108 about a pivot axis 138.

In operation, the height of the sensor 108 may be adjusted such that a distance between a focal axis 122 of the sensor 108 and a cutting axis 126 of the cutting disk 34 is equal to the defined offset. In such instances, as the harvester 10 traverses the field 24, the topper assembly 30 may be altered to generally align the focal axis 122 of the sensor 108 with the target 39 (e.g., a maximum height) of the to-be-harvested crop C. As the distance between the focal axis 122 and the cutting axis 126 is fixed and equal to the offset distance, the height of a severed upper portion Cᵤₚ of the crop C will generally be equal to the defined offset. When the harvester 10 approaches a subsequent to be harvested crop C, the topper assembly height may be altered to align the focal axis 122 with a target 39 (e.g., a maximum height) of the subsequent crop C. In some cases, if an error occurs and a subsequent crop C is detected prior to the current crop C, the target 39 is likely to be positioned above the current crop C. As such, the upper portion Cᵤₚ may be less than the defined offset, which can prevent the loss of the harvestable stalk Cₛ of the crop C.

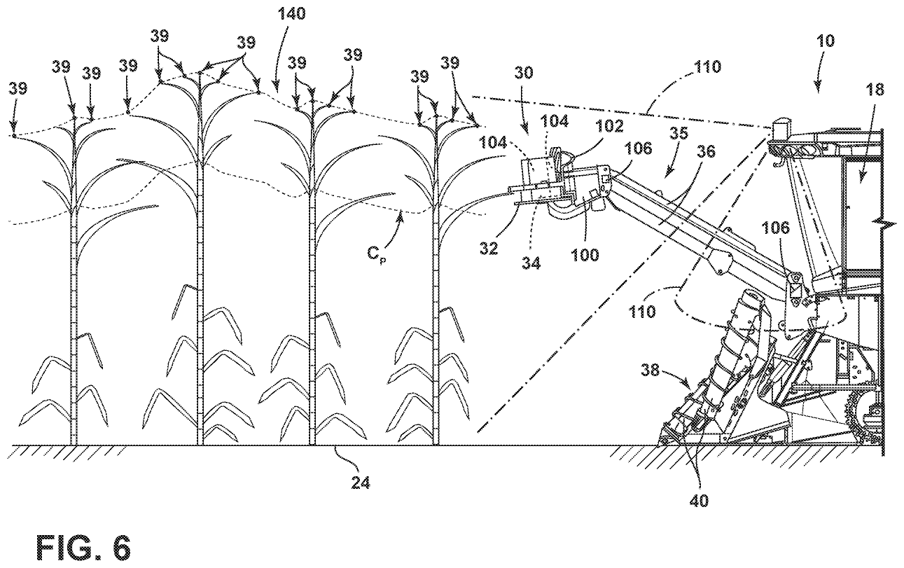

Referring now to FIG. 6, a side perspective view of the harvester 10 in the field 24 with a sensor 108 mounted to a component vehicle rearward of the topper assembly 30 is illustrated in accordance with various aspects of the present disclosure. In the illustrated example, the sensor 108 is operably coupled to the cab 18 of the harvester 10. However, it will be appreciated that one or more sensors 108 may be operably coupled with any other component of the harvester 10 without departing from the scope of the present disclosure.

In the example illustrated in FIG. 6, the sensor 108 can capture crop data. In some instances, the crop data may be used to generate a point cloud 140 (or other representation of the captured crop data) of the canopy profile of the crop C. In some cases, the point cloud 140 may be limited to the crop C within a current pass along the field 24.

As provided herein, an input indicative of a defined offset from a target 39, such as a maximum height of the crop C, may be received. Based on the canopy profile, the adjustment assembly 35 may alter the position of the cutting disk 34 to maintain the cutting disk 34 within a range of a cutting position Cₚ, wherein the distance between the target 39 and the cutting position is equal to the defined offset.

In some examples, the sensor 108 may also be configured to capture crop data related to crops C that will be harvested in an upcoming pass. In such instances, the crop data may be used to determine a canopy profile proactively so that one or more alterations of the topper assembly 30 may be preprogrammed prior to the crop C being the next to be harvested crop C.

Additionally or alternatively, the canopy profile may be captured in conjunction with location data so that a canopy profile map may be created. The canopy profile map may be provided to one or more input devices 204 and/or other electronic devices to improve the productivity and yield of the field 24.

Additionally or alternatively, the sensor 108 may further be configured to detect a vehicle, such as a trailer, within the field 24. Moreover, once a vehicle is detected, the location of the vehicle relative to the harvester 10 and/or type of vehicle may be established. Furthermore, when the vehicle is detected within a defined zone proximate to the harvester 10 and is identified as a trailer that is capable of retaining harvested crop, the harvester 10 may automatically and/or within operator intervention, begin directing the harvested crop C into the vehicle.

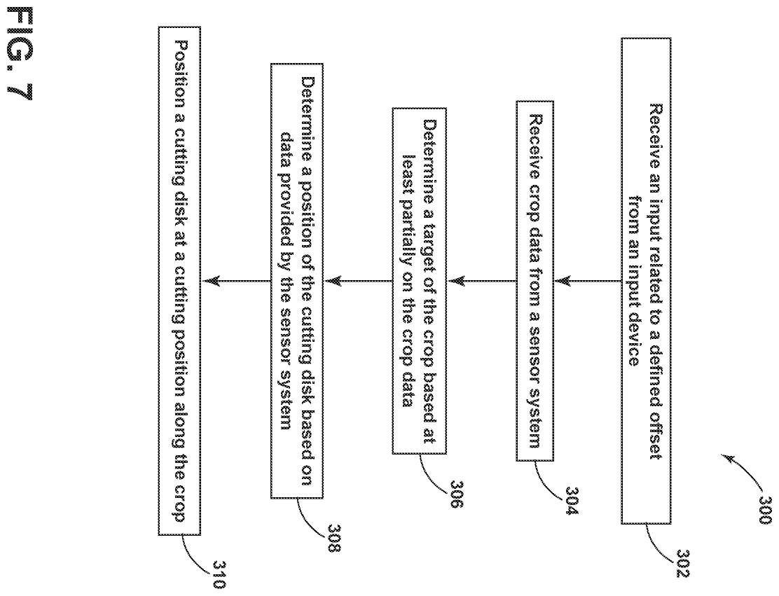

Referring now to FIG. 7, a flow diagram of a method 300 for operating an agricultural harvester is illustrated in accordance with aspects of the present subject matter. In general, the method 300 will be described herein with reference to the agricultural harvester 10 and related components described with reference to FIGS. 1-5. It will be appreciated, however, that the disclosed method 300 may be implemented with harvesters having any other suitable configurations and/or within systems having any other suitable system configuration. In addition, although FIG. 7 depicts steps performed in a particular order for purposes of illustration and discussion, the methods discussed herein are not limited to any particular order or arrangement. One skilled in the art, using the disclosures provided herein, will appreciate that various steps of the method disclosed herein can be omitted, rearranged, combined, and/or adapted in various ways without deviating from the scope of the present disclosure.

As shown in FIG. 7, at (302), the method 300 may include receiving an input related to a defined offset from an input device. In some examples, the input may be based received through one or more of the input device(s), which may include one or more positioning device(s) for generating position data associated with the location of the harvester, one or more user interfaces for allowing operator inputs to be provided to the computing system (e.g., buttons, knobs, dials, levers, joysticks, touch screens, and/or the like), one or more other internal data sources associated with the harvester (e.g., other devices, databases, etc.), one or more external data sources (e.g., a remote computing device or server, including, for instance, a machine-learning computing system), and/or any other suitable input device(s).

At (304), the method 300 can include receiving crop data from a sensor system. In various examples, the sensor system can include one or more sensors that may be vision-based or wave-based (e.g., cameras/imagers, radar sensors, ultrasound sensors, LIDAR devices, etc.). In various examples, the crop data may be indicative of a type of crop and the defined offset is at least partially based on the type of crop.

At (306), the method 300 can include determining a target of the crop based at least partially on the crop data. In some instances, the target is a maximum height of the crop.

At (308), the method 300 can include determining a position of the cutting disk based on data provided by the sensor system. At (310), the method 300 can include positioning a cutting disk at a cutting position along the crop, wherein the cutting position is the defined offset below the target. In some instances, positioning the cutting disk at the cutting position along the crop further comprises moving the cutting disk a movement distance equal to a difference between a current position of the cutting disk and the cutting position. Additionally or alternatively, positioning the cutting disk at the cutting position along the crop further comprises activating an adjustment assembly to alter a position of the cutting disk relative to a frame of the harvester.

It is to be understood that the steps of any method disclosed herein may be performed by a computing system upon loading and executing software code or instructions which are tangibly stored on a tangible computer-readable medium, such as on a magnetic medium, e.g., a computer hard drive, an optical medium, e.g., an optical disc, solid-state memory, e.g., flash memory, or other storage media known in the art. Thus, any of the functionality performed by the computing system described herein, such as any of the disclosed methods, may be implemented in software code or instructions which are tangibly stored on a tangible computer-readable medium. The computing system loads the software code or instructions via a direct interface with the computer-readable medium or via a wired and/or wireless network. Upon loading and executing such software code or instructions by the controller, the computing system may perform any of the functionality of the computing system described herein, including any steps of the disclosed methods.

The term “software code” or “code” used herein refers to any instructions or set of instructions that influence the operation of a computer or controller. They may exist in a computer-executable form, such as vehicle code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

This written description uses examples to disclose the technology, including the best mode, and also to enable any person skilled in the art to practice the technology, including making and using any devices or systems and performing any incorporated methods. The patentable scope of the technology is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A system for an agricultural harvester, the system comprising:
a topper assembly including a cutting disk configured to severe an upper portion of a crop;
a sensor system including a first sensor configured to capture crop data associated with the crop; and
a computing system including one or more processors and one or more non-transitory computer-readable media that collectively store instructions that, when executed by the one or more processors, configure the computing system to perform operations, the operations comprising:
receiving an input related to a defined offset;
receiving the crop data from the sensor system;
determining a target of the crop based at least partially on the crop data; and
positioning the cutting disk at a cutting position along the crop, wherein the cutting position is the defined offset below the target.

2. The system of claim 1, wherein the first sensor is a vision-based sensor, and wherein the crop data is image data.

3. The system of claim 1, wherein the target is a maximum height of the crop.

4. The system of claim 3, wherein the operations further comprise:
determining a position of the cutting disk based on data provided by a second sensor, wherein positioning the cutting disk at the cutting position along the crop further comprises moving the cutting disk a movement distance equal to a difference between a current position of the cutting disk and the cutting position.

5. The system of claim 1, further comprising:
an input device configured to provide the defined offset to the computing system.

6. The system of claim 1, wherein the operations further comprise:
generating a canopy map based on the crop data.

7. The system of claim 1, wherein the first sensor is operably coupled with the topper assembly.

8. The system of claim 1, wherein the first sensor is operably coupled with a cab positioned vehicle rearward of the topper assembly.

9. The system of claim 1, further comprising:
an adjustment assembly configured to alter a position of the cutting disk relative to a frame of the harvester.

10. A computer-implemented method for agricultural harvesting, the computer-implemented method comprising:
receiving, from an input device, an input related to a defined offset;
receiving, from a sensor system, crop data;
determining a target of the crop based at least partially on the crop data; and
positioning a cutting disk at a cutting position along the crop, wherein the cutting position is the defined offset below the target.

11. The computer-implemented method of claim 10, wherein the target is a maximum height of the crop.

12. The computer-implemented method of claim 10, further comprising:
determining a position of the cutting disk based on data provided by the sensor system.

13. The computer-implemented method of claim 12, wherein positioning the cutting disk at the cutting position along the crop further comprises moving the cutting disk a movement distance equal to a difference between a current position of the cutting disk and the cutting position.

14. The computer-implemented method of claim 12, wherein positioning the cutting disk at the cutting position along the crop further comprises activating an adjustment assembly to alter a position of the cutting disk relative to a frame of the harvester.

15. The computer-implement method of claim 13, wherein receiving, from the input device, the input related to the defined offset further comprises receiving crop data indicative of a type of crop, and wherein the defined offset is at least partially based on the type of crop.

16. A system for an agricultural harvester, the system comprising:
a topper assembly including a cutting disk configured to severe an upper portion of a crop;
a sensor system including a first sensor configured to capture crop data associated with the crop; and
a computing system including one or more processors and one or more non-transitory computer-readable media that collectively store instructions that, when executed by the one or more processors, configure the computing system to perform operations, the operations comprising:
receiving an input related to a defined offset;
receiving the crop data from the sensor system;
determining a maximum height of the crop based at least partially on the crop data; and
positioning the cutting disk at a cutting position along the crop, wherein the cutting position is the defined offset below the maximum height.

17. The system of claim 16, wherein the operations further comprise:
generating a canopy map based on the maximum height of the crop within a current pass of the harvester within a field.

18. The system of claim 17, wherein the operations further comprise:
generating a canopy map based on the maximum height of the crop within a subsequent pass of the harvester within the field.

19. The system of claim 16, wherein the first sensor is a vision-based sensor, and wherein the crop data is image data.

20. The system of claim 16, further comprising:
an adjustment assembly configured to alter a position of the cutting disk relative to a frame of the harvester.
